(19) United States
(12) Patent Application Publication
(10) Pub. No.: US 2013/0235553 A1
(43) Pub. Date: Sep. 12, 2013

(54) ILLUMINATION DEVICE

(71) Applicants: WINSKY TECHNOLOGY LIMITED, Hong Kong (HK); KUN-HSIN TECHNOLOGY INC., Teipei City (TW)

(72) Inventor: KUN CHUAN LIN, TAIPEI CITY (TW)

(73) Assignees: KUN-HSIN TECHNOLOGY INC., TAIPEI CITY (TW); WINSKY TECHNOLOGY LIMITED, HONG KONG (HK)

(21) Appl. No.: 13/785,169

(22) Filed: Mar. 5, 2013

(30) Foreign Application Priority Data
Mar. 6, 2012 (TW) 101204040

(51) Int. Cl. F21V 13/02; F21V 29/00; F21V 7/00

(52) U.S. Cl. CPC F21V 13/02; F21V 7/00; F21V 29/22
USPC 362/84; 362/235; 362/249.02

(57) ABSTRACT

The subject invention relates to an illumination device, comprising a lamp holder having a base; and a plurality of LED dies directly bonded on the base. The structure of the illumination device of the subject invention can eliminate unnecessary elements, reduce process time and further improve lighting efficiency.

### BACKGROUND OF THE INVENTION

1. Field of the Invention

The subject invention relates to an illumination device, and more particularly to light-emitting diode (LED) illumination device.

2. Description of the Related Art

Conventional fluorescent tube illumination has the following disadvantages; service life is short; lighting efficiency is low; and discarded fluorescent tubes are likely to pollute the environment. LED is power-saving and to has high lighting efficiency, which can resolve the problems associated with conventional fluorescent tubes.

The dimension of fluorescent lamps has fixed for many years, and in order to minimize cost associated with the switch to LED, for example when altering ceiling decoration, new LED lamps have always been developed in compliance with the existing dimension of the fluorescent lamps. For example, ROC Patent No. M413802 (LED illumination tube) has disclosed LED illumination applicable to fluorescent lamps with existing dimension, in which multiple LEDs are borne on a substrate, and a surface of a heat dissipation plate is adhered to the substrate to facilitate heat dissipation of the LEDs. The surface of the heat dissipation plate adhered to the substrate is coated with thermal grease at the adhered part. To comply with the heat dissipation requirement, the other surfaces of the heat dissipation plate may further be designed with heat dissipation fins to increase the surface area and improve the heat dissipation efficiency. Then, the above assembly is placed in a light-transmissive tube.

However, due to the need for heat dissipation, the heat dissipation structure contributes to a significant increase in the manufacturing cost of current LED lamp assembly. As a result, the manufacturing cost of LED dies having illumination function only accounts for less than 10% of the overall cost of the illumination device, so having such structure is highly uneconomical.

Therefore, the subject invention intends to provide an illumination device, which can reduce the manufacturing cost of the heat dissipation structure and the assembling time, and can further improve the overall lighting efficiency of LED illumination device.

### SUMMARY OF THE INVENTION

The subject invention aims at resolving the problems caused by the disadvantages of prior art, and manufacturing an illumination device at lower cost but having higher productivity and heat dissipation efficiency. Compared with technology currently available on the market, the illumination device of the subject invention is more economical, saves unnecessary manufacturing cost, reduces processing time and further improves lighting efficiency.

In an embodiment, the subject invention provides an illumination device, which includes a lamp holder having a base, and a plurality of LED dies directly bounded on the base.

### BRIEF DESCRIPTION OF THE DRAWINGS

The invention is described according to the appended drawings where:

FIG. 1a shows an illumination device according to an embodiment of the subject invention;

FIG. 1b is a sectional view of the illumination device of FIG. 1a;

FIG. 2 shows an illumination device according to another embodiment of the subject invention;

FIG. 3 is a sectional view of an illumination device according to another embodiment of the subject invention;

FIG. 4 is a sectional view of an illumination device according to another embodiment of the subject invention;

FIG. 5 shows a configuration of an illumination device according to another embodiment of the subject invention;

FIG. 6a is a schematic view of a circuit configuration of an illumination device according to an embodiment of the subject invention; and

FIG. 6b is a schematic view of a circuit configuration of an illumination device according to still another embodiment of the subject invention.

### PREFERRED EMBODIMENT OF THE INVENTION

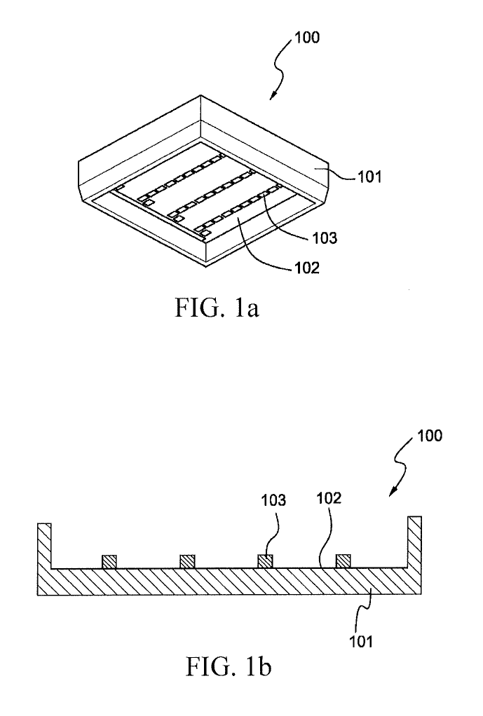

An embodiment of an illumination device according to the subject invention is shown in FIG. 1a. An illumination device 100 includes a lamp holder 101 having a base (namely a bottom surface) 102, and a plurality of LED dies 103 directly bonded on the base 102. FIG. 1b is a sectional view of the illumination device 100 of FIG. 1a. Configuration of the illumination device of the subject invention can be better understood when making reference to sectional view.

In the illumination device according to the subject invention, based on design requirements, the plurality of LED dies 103 may be directly bonded on the base 102 of the illumination device, such as randomly configured on the base 102 (for example, in a manner of series connection, parallel connection, or series-parallel connection) in compliance with a luminance requirement or a circuit configuration requirement. In addition, since the configured LED dies are directly bonded on the base 102, the base 102 itself can be used as a heat dissipation plate which has a large heat dissipation area and a good heat dissipation effect. Therefore, heat generated by the LED dies during operation can be dissipated without adding any extra heat dissipation fin. In addition, different from prior art where dies are bonded on a submount and then attached to the base through the submount, the LED dies 103 are directly bonded on the base 102 of the illumination device. Therefore, the illumination device according to the subject invention enables heat to be directly dissipated through the base 102 so that heat will not gather in local areas, thereby achieving a desired heat dissipation effect.

In a preferred embodiment, the base 102 of the illumination device 100 is a heat dissipation base having a desirable heat conduction property, and the material thereof may be a metal, ceramic or composite material having a high thermal conductivity coefficient. The metal material may include copper, aluminum, tin, iron or an alloy thereof. Having the desired heat conduction property will heat generated during illumination of the LED dies to dissipate effectively, so that heat will not gather on the LED dies, thereby improving lighting performance and reliability of the LED dies.

In a preferred embodiment, the dimension of the illumination device may be about 10 cm*60 cm, 6.5 cm*60 cm, 60 cm*60 cm or 60 cm*120 cm, which complies with the specification of general indoor illumination devices, so that the illumination device according to the subject invention can directly replace conventional illumination device in a more economical manner without altering the existing ceiling decoration, and can achieve the required brightness of illumination in a power-saving manner.

The structure of the illumination device according to the subject invention is simple, thereby eliminating unnecessary elements, saving cost, and reducing assembling time. In addition, due to having the desired heat dissipation effect, lighting efficiency is further improved.

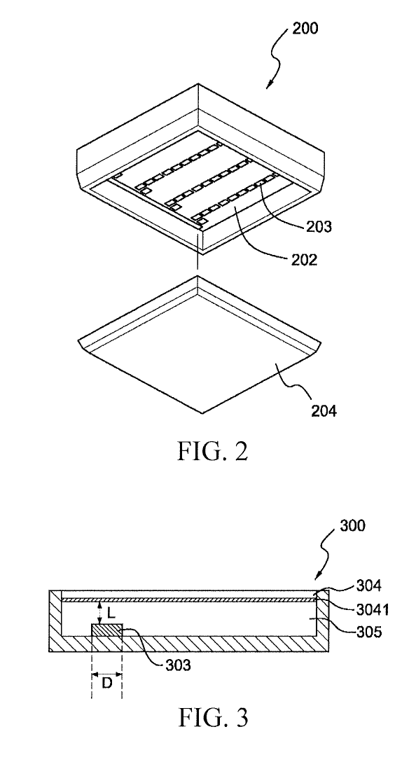

Another preferred embodiment of the subject invention is shown in FIG. 2. An illumination device 200 further includes a lamp shade 204. In a preferred embodiment, the lamp shade 204 has a fluorescent layer coated on its internal surface. In another preferred embodiment, a lamp shade body of the lamp shade 204 is provided with a fluorescent layer composed of evenly distributed fluorescent powder. The lamp shade 204 having the fluorescent layer can protect LED dies 203 in the illumination device 200, and can also change the wavelength of light emitted by the LED. For example, blue LED dies 203 emit blue light and the fluorescent layer may include cerium doped yttrium aluminum garnet (Ce:YAG) and terbium aluminum garnet (YAG) to convert the blue light to white light, so as to be more suitable for general indoor illumination. In a preferred embodiment, the thickness of the fluorescent layer coated on the internal surface of the lamp shade 204 is about 2 μm to 100 μm.

FIG. 3 is a sectional view of an illumination device 300 according to another preferred embodiment of the subject invention. A surface of a lamp shade 304 is coated with a fluorescent layer 3041. The side length of an LED die 303 on the illumination device 300 is denoted as D, and the range of D is about 60 μm to 3 mm. The fluorescent layer 3041 of the lamp shade 304 does not come in direct contact with a surface of the LED die 303. Instead, a distance L exists between the surface of the LED die 303 and the fluorescent layer 3041 of the lamp shade, in which L/D≧0.3, thereby achieving the desired lighting efficiency.

In a preferred embodiment, a space 305 between the surface of the LED die 303 and the fluorescent layer 3041 of the lamp shade is filled with a gas. The gas may include an inert gas (such as nitrogen (N2), helium (He) or argon (Ar)) or dry air to protect the LED die 303 from being oxidized or getting wet, so that lighting performance is not affected. Alternatively, the space 305 between the surface of the LED die 303 and the fluorescent layer 3041 of the lamp shade is in a vacuum state to achieve the same effect.

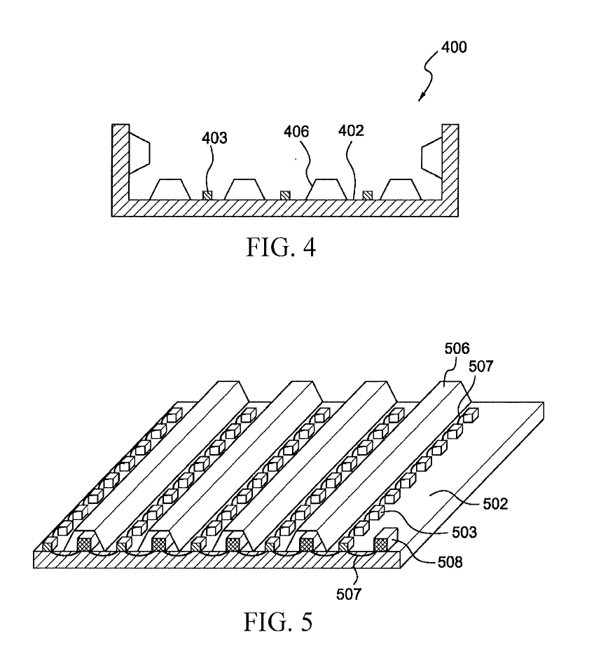

FIG. 4 is a sectional view of an illumination device 400 according to another preferred embodiment of the subject invention. In the illumination device 400, at least one reflecting plate 406 or other reflecting component is arranged on a base 402. In addition, a reflecting plate may further be arranged on an inner wall of a lamp holder, so as to reflect light emitted by LED dies 403, thereby improving lighting efficiency of the illumination device 400.

FIG. 5 is a schematic view of configuration of an illumination device according to a preferred embodiment of the subject invention. An illumination device 500 further includes a plurality of wires 507 or lines or conductor pads formed on a base 502, so as to be electrically connected to a plurality of LED dies 503 or a driving circuit 508. Further, the driving circuit 508 may be arranged on the base 502, or between the base 502 and a reflecting plate 506, so as to be connected an external power source to drive and control lighting of the LED dies 503. The driving circuit 508 may have multiple implementation aspects, such as, a bridge rectifier, a regulated rectifier, a converter and/or a current-limiting resistor.

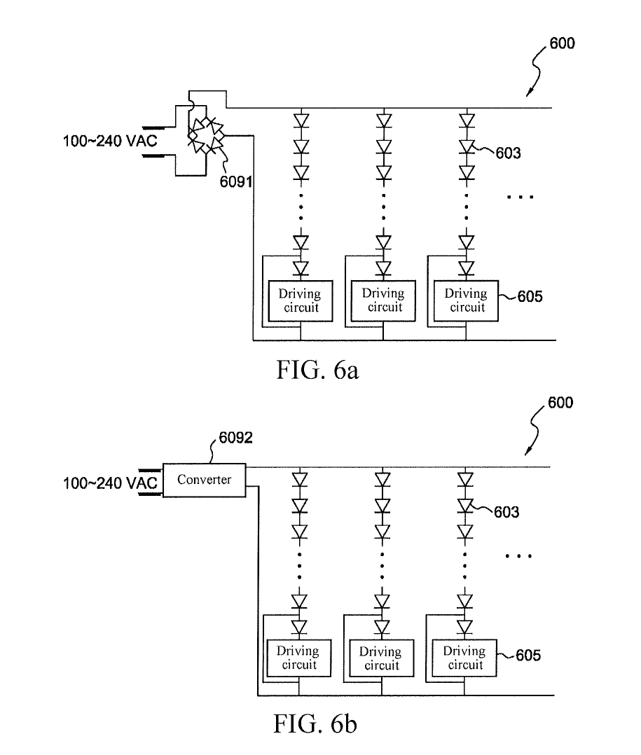

FIG. 6a is a schematic view of circuit configuration of an illumination device 600 according to an embodiment of the subject invention. A plurality of LED dies 603 and a driving circuit 605 are connected in series-parallel, and are electrically connected to an external power source through a bridge rectifier 6091, in which the external power source may be an alternating-current power source of 110 V or 240 V. When the illumination device 600 is operated, the bridge rectifier 6091 can convert the external power source to a direct-current power source with a power output of 110 W to 220 W, so as to supply a direct-current voltage of 154 V or 308 V to the plurality of LED dies 603 formed and connected to in parallel and the driving circuit 605 connected in series. In a preferred embodiment, the driving circuit 605 outputs a constant current of 20 mA to 60 mA to the LED dies 603, so as to protect the LED and maintain stable lighting.

FIG. 6b shows circuit configuration of an illumination device 600 according to still another embodiment of the subject invention. A plurality of LED dies and a driving circuit connected in series-parallel connection are electrically connected to an external alternating-current power source of 110 V or 240 V through a converter 6902. The converter 6902 can convert the alternating-current power source of 110 V or 240 V to a direct-current power source with a power output of 40 W to 320 W, so as to supply a direct-current voltage of 12 V to 54 V to parallel-connected combinations formed by the plurality of LED dies and the driving circuit 605 connected in series.

The technical contents and features of the subject invention have been described above. However, persons skilled in the art can make various variations and modifications without departing from the teachings and disclosure of the subject invention. Therefore, the scope of the subject invention is not limited to the disclosed embodiments, and includes other variations and modifications made without departing from the subject invention. The scope of the subject invention is defined by the scope of the appended claims.

What is claimed is:

1. An illumination device, comprising:
a lamp holder, having a base; and
a plurality of light-emitting diode (LED) dies, directly bonded on the base.

2. The illumination device according to claim 1, further comprising a lamp shade, wherein the lamp shade has a fluorescent layer, the fluorescent layer is coated on a surface of the lamp shade.

3. The illumination device according to claim 1, further comprising a lamp shade, wherein the lamp shade is provided with fluorescent materials.

4. The illumination device according to claim 2, wherein the thickness of the fluorescent layer on the surface of the lamp shade is 2 μm to 100 μm.

5. The illumination device according to claim 2, wherein a side length of a die among the LED dies is D, a distance between the LED dies and the fluorescent layer on the surface of the lamp shade is L, with the range of D is about 60 μm to 3000 μm, and L/D≧0.3.

6. The illumination device according to claim 1, further comprising at least one reflecting plate arranged on the base or on an inner wall of the lamp holder.

7. The illumination device according to claim 2, further comprising a gas filled in a space between the lamp holder and the lamp shade, wherein the gas comprises at least one of the following gases: nitrogen (N₂), helium (He), argon (Ar) and dry air.

8. The illumination device according to claim 1, further comprising at least one wire electrically connecting the plurality of LED dies.

9. The illumination device according to claim 6, further comprising a driving circuit arranged on the base or between the base and the reflecting plate, so as to be connected to an external power source to drive the plurality of LED dies.

10. The illumination device according to claim 1, wherein the base is a heat dissipation base formed of a metal, ceramic or composite material.

11. The illumination device according to claim 1, wherein the dimension of the illumination device is about 10 cm*60 cm, 6.5 cm*60 cm, 60 cm*60 cm or 60 cm*120 cm.

12. The illumination device according to claim 2, wherein a space between the lamp holder and the lamp shade is in a vacuum state.
